(19) United States
(12) Patent Application Publication
(10) Pub. No.: US 2015/0044578 A1
(43) Pub. Date: Feb. 12, 2015

(54) BINDERS DERIVED FROM POLYAMIC ACIDS FOR ELECTROCHEMICAL CELLS

(71) Applicant: E I DU PONT DE NEMOURS AND COMPANY, Wilmington, DE (US)

(72) Inventors: KOSTANTINOS KOURTAKIS, Media, PA (US); Biswajit Choudhury, Wilmington, DE (US); Gerard Joseph Grier, Wilmington, DE (US)

(21) Appl. No.: 14/341,904

(22) Filed: Jul. 28, 2014

Related U.S. Application Data
(60) Provisional application No. 61/862,972, filed on Aug. 7, 2013.

(51) Int. Cl. H01M 4/62; H01M 4/505; H01M 4/525; H01M 4/131

(52) U.S. Cl. CPC H01M 4/622; H01M 4/131; H01M 4/505; H01M 4/525; H01M 2004/028
USPC 429/341; 429/217; 252/182.1

(57) ABSTRACT

Described are binder precursor compositions for cathodes containing polyamic acid which has a anhydride to amine ratio of greater than or equal to 0.985:1 to less than or equal to 1.10:1. These compositions are useful as cathodes in electrochemical cells, such as lithium ion batteries. Also described are electrodes comprising the binder precursor compositions and methods to prepare the electrodes.

### FIELD OF THE INVENTION

The disclosure herein relates to binder precursor compositions containing polyamic acid which has a anhydride to amine ratio of greater than or equal to 0.985:1 to less than or equal to 1.10:1. These compositions are useful as cathodes in electrochemical cells, such as lithium ion batteries.

### BACKGROUND

The need for high voltage (HV) lithium batteries is becoming increasingly important for the successful commercialization of hybrid electric vehicle, plug in hybrid vehicle and electric vehicles. HV application is more demanding on the battery and requires an enhancement of its specifications particularly, increasing the power/energy densities and cycle life. Beside these, enhancing the safety under normal and abusive operating conditions and lowering manufacturing cost are also needed for the success in HV technology. One way to increase the energy density of the battery is to use cathode materials operating at high voltages up to 5.0 V (vs. Li/Li+). The use of such HV cathode poses very stringent requirement for the electrochemical stability of other components, such as the electrolyte, binder, electrolyte additive, that are used in conjunction with the cathode electrode in a battery pack. In a conventional Li-ion battery poly(vinylidene fluoride) or PVDF is used as binder material. PVDF has been most widely adopted as a binder for anode and cathode electrodes in Li-ion batteries. PVDF has strong binding strength, low flexibility and suitable for electrode casting and charge/discharge cycling under normal lithium battery condition. However, PVDF is generally electrochemically stable only up to about 4.7V, which makes PVDF unsuitable for using as a binder material in HV-LIB. The electrochemical stability limitation of PVDF creates a need of polymer binder development for high voltage LIB application.

Polyimides are an important class of high performance polymers and are used in a wide range of applications e.g., microelectronics, aviation industry, separation membranes, and separators for batteries. They also have attractive properties for binder components in electrodes for lithium ion batteries partly because of their high thermal stability. Thus there is a need for polyimide and polyimide precursor compositions that are stable at high potentials, particularly for use in HV cathodes.

### SUMMARY

Disclosed herein is a binder precursor composition for a cathode of an electrochemical cell comprising an electroactive cathode material, and a polyamic acid, wherein the polyamic acid has an anhydride to amine ratio of greater than or equal to about 0.985:1 to less than or equal to about 1.10:1. Also disclosed herein is a cathode comprising the binder precursor composition or an imidized form of the binder precursor composition. The imidization can be partial or complete.

Also disclosed herein is an electrochemical cell comprising:
(a) a housing;
(b) an anode and a cathode comprising an imidized form of the binder precursor composition as described above, disposed in the housing and in ionically conductive contact with one another;
(c) an electrolyte composition disposed in the housing and providing an ionically conductive pathway between the anode and the cathode; and
(d) a porous separator between the anode and the cathode.

Also disclosed herein is a method, comprising the steps of:
(a) combining a polyamic acid that has an anhydride to amine ratio of greater than or equal to about 0.985:1 to less than or equal to about 1.10:1 with an electroactive cathode material to form a binder precursor mixture; and
(b) applying the binder precursor mixture to a current collector.

### DETAILED DESCRIPTION

“Dianhydride” as used herein is intended to include dianhydrides, precursors or derivatives thereof, which may not technically be a dianhydride but would nevertheless react with a diamine to form a polyamic acid which could in turn be converted into a polyimide.

“Diamine” as used herein is intended to include diamines, precursors or derivatives thereof, which may not technically be a diamine but would nevertheless react with a dianhydride to form a polyamic acid which could in turn be converted into a polyimide.

“Electrolyte composition” as used herein, refers to a chemical composition suitable for use as an electrolyte in an electrochemical cell. An electrolyte composition typically comprises at least one solvent and at least one electrolyte salt.

“Electrolyte salt” as used herein, refers to an ionic salt that is at least partially soluble in the solvent of the electrolyte composition and that at least partially dissociates into ions in the solvent of the electrolyte composition to form a conductive electrolyte composition.

“Anode” refers to the electrode of an electrochemical cell, at which oxidation occurs. In a galvanic cell, such as a battery, the anode is the negatively charged electrode. In a secondary (i.e. rechargeable) battery, the anode is the electrode at which oxidation occurs during discharge and reduction occurs during charging.

“Cathode” refers to the electrode of an electrochemical cell, at which reduction occurs. In a galvanic cell, such as a battery, the cathode is the positively charged electrode. In a secondary (i.e. rechargeable) battery, the cathode is the electrode at which reduction occurs during discharge and oxidation occurs during charging.

“Lithium ion battery” refers to a type of rechargeable battery in which lithium ions move from the anode to the cathode during discharge, and from the cathode to the anode during charge.

“Current collector” shall mean a structural part of an electrode assembly whose primary purpose is to conduct electricity between the actual working (or reacting) part of the electrode, i.e., the Ni electrode active mass, and the terminals of an electrochemical cell.

Described herein is a binder precursor composition for a cathode of an electrochemical cell, comprising a solvent, an electroactive cathode material, and a polyamic acid, wherein the polyamic acid has an anhydride to amine ratio of greater than or equal to about 0.985:1 to less than or equal to about 1.10:1.

The binder precursor composition can be in any fluid form, such as a slurry, dispersion, or solution. The binder precursor composition can additionally comprise a solvent, which can be any solvent that is inert to the polyamic acid, but is typically the solvent used in the preparation of the polyamic acid, discussed further below.

Polyamic acids are the reaction product of a tetracarboxylic acid dianhydride and an organic diamine. In one embodiment the dianhydride is aromatic, in another embodiment the diamine is aromatic, and in another embodiment both the dianhydride and the diamine are aromatic. In another embodiment the polyamic acid is derived from at least 25, or at least 50, or at least 75 mole percent of the total amount of aromatic dianhydride, based upon the total dianhydride content of the polyimide precursor, and/or at least 25, or at least 50, or at least 75 mole percent of of the total amount aromatic diamine, based upon the total diamine content of the polyimide precursor.

The polyamic acids can be prepared by any suitable method, such as those discussed in Polyimides (Encyclopedia Of Polymer Science and Technology, RG Bryant, 2006, DOI: 10.1002/0471440264.pst272.pub2, John Wiley & Sons, Inc.). One method includes dissolving the diamine in a dry solvent and slowly adding the dianhydride under conditions of agitation and controlled temperature, and in a dry atmosphere, such as nitrogen.

Numerous embodiments of formation are possible, such as: (a) a method wherein the diamine components and dianhydride components are preliminarily mixed together and then the mixture is added in portions to a solvent while stirring, (b) a method wherein a solvent is added to a stirring mixture of diamine and dianhydride components, (c) a method wherein diamines are exclusively dissolved in a solvent and then dianhydrides are added thereto, (d) a method wherein the dianhydride components are exclusively dissolved in a solvent and then amine components are added thereto, (e) a method wherein the diamine components and the dianhydride components are separately dissolved in solvents and then these solutions are mixed in a reactor, (f) a method wherein the polyamic acid with excessive amine component and another polyamic acid with excessive dianhydride component are preliminarily formed and then reacted with each other in a reactor, particularly in such a way as to create a non-random or block copolymer, and (g) a method wherein a specific portion of the amine components and the dianhydride components are first reacted and then the residual diamine components are reacted, or vice versa, (h) a method wherein the components are added in part or in whole in any order to either part or whole of the solvent, also where part or all of any component can be added as a solution in part or all of the solvent, and (i) a method of first reacting one of the dianhydride components with one of the diamine components giving a first polyamic acid, then reacting the other dianhydride component with the other amine component to give a second polyamic acid, and then combining the polyamic acids in any one of a number of ways prior to film or fiber formation.

The temperature of the reaction is usually from about −30° C. to about 100° C., or about 0 to about 100° C., or about 10° C. to about 40° C. Typically, the reaction is carried out at room temperature.

The binder precursor composition described herein has a anhydride to amine ratio of greater than or equal to approximately 0.985:1, or 0.990:1, or 1.00:1, or 1.01:1; to less than or equal to approximately 1.01:1, or 1.02, or 10.3, or 1.05:1, or 1.10:The anhydride to amine ratio is the molar ratio of the repeating units that are derived from the anhydride component and the repeating units derived from the diamine component in the polyamic acid, and is calculated from the starting reagents. In one embodiment the polyamic acid has an anhydride to amine ratio of greater than or equal to about 0.985:1 to less than or equal to about 1.10:1; in another embodiment greater than or equal to about 0.990:1 to less than or equal to about 1.05:1; in another embodiment greater than or equal to about 0.990:1 to less than or equal to about 1.01:1; in another embodiment greater than or equal to about 1.01:1 to less than or equal to about 1.03:1.

Suitable organic dianhydrides include, but are not limited to, pyromellitic dianhydride (PMDA); biphenyltetracarboxylic dianhydride (BPDA); 3,3′,4,4′-benzophenone tetracarboxylic dianhydride (BTDA); 2,3,6,7-naphthalene tetracarboxylic dianhydride; 3,3′,4,4′-tetracarboxybiphenyl dianhydride; 1,2,5,6-tetracarboxynaphthalene dianhydride; 2,2′,3,3′-tetracarboxybiphenyl dianhydride; 2,2-bis(3,4-dicarboxyphenyl) propane dianhydride; bis(3,4-dicarboxyphenyl) sulfone dianhydride; bis(3,4-dicarboxyphenyl) ether dianhydride; naphthalene-1,2,4,5-tetracarboxylic dianhydride; naphthalene-1,4,5,8-tetracarboxylic dianhydride; pyrazine-2,3,5,6-tetracarboxylic dianhydride; 2,2-bis(2,3-dicarboxyphenyl) propane dianhydride; 1,1-bis(2,3-dicarboxyphenyl) ethane dianhydride; 1,11-bis(3,4-dicarboxyphenyl) ethane dianhydride; bis(2,3-dicarboxyphenyl) methane dianhydride; bis(3,4-dicarboxyphenyl) methane dianhydride; benzene-1,2,3,4-tetracarboxylic dianhydride; 3,4,3′,4′-tetracarboxybenzophenone dianhydride; perylene-3,4,9,10-tetracarboxylic dianhydride; bis-(3,4-dicarboxyphenyl) ether tetracarboxylic dianhydride; 4,4′-oxydiphthalic anhydride; 3,3′,4,4′-diphenyl sulfone tetracarboxylic dianhydride; 2,2-bis(3,4-dicarboxyphenyl) hexafluoropropane; Bisphenol A dianhydride (4,4′-(4,4′-isopropylidenediphenoxy)bis(phthalic anhydride)); and mixtures thereof. In one embodiment the organic dianhydrides is pyromellitic dianhydride, 3,3′,4,4′-biphenyl tetracarboxylic dianhydride, 3,3′,4,4′-benzophenone tetracarboxylic dianhydride, 4,4′-oxydiphthalic anhydride, 3,3′,4,4′-diphenyl sulfone tetracarboxylic dianhydride, 2,2-bis(3,4-dicarboxyphenyl) hexafluoropropane, Bisphenol A dianhydride, or mixtures thereof.

Suitable organic diamines include, but are not limited to, oxydianiline (ODA), 3,4′-oxydianiline, 1,3-bis-(4-aminophenoxy)benzene, 4,4′-oxydianiline, 1,4-diaminobenzene, 1,3-diaminobenzene, 2,2′-bis(trifluoromethyl)benzidene, 4,4′-diaminobiphenyl, 4,4′-diaminodiphenyl sulfide, 9,9′-bis(4-amino)fluorine, 1,3-bis(4-aminophenoxy)benzene (RODA), and 1,4 phenylenediamine (PDA); m-phenylenediamine; p-phenylenediamine; 4,4′-diaminodiphenyl propane; 4,4′-diaminodiphenyl methane benzidine; 4,4′-diaminodiphenyl sulfide; 4,4′-diaminodiphenyl sulfone; 4,4′-diaminodiphenyl ether; 1,5-diaminonaphthalene; 3,3′-dimethyl benzidine; 3,3′-dimethoxy benzidine; bis-(para-beta-amino-t-butylphenyl)ether; 1-isopropyl-2,4-m-phenylenediamine; m-xylylenediamine; p-xylylenediamine; di(paraminocyclohexyl) methane; hexamenthylenediamine; heptamethylenediamine; octamethylenediamine; decamethylenediamine; nonamethylenediamine; 4,4-dimethylheptamethyienedia-2,11-diaminododecane; 1,2-bis(3-aminopropoxyethane); 2,2-dimethylpropylenediamine; 3-methoxyhexamethylenediamine; 2,5-dimethyl hexamethylenediamine; 3-methylheptamethylenediamine; piperazine; 1,4-diamino cyclohexane; 1,12-diamino octadecane; 2,5-diamino-1,3,4-thiadiazole; 2,6-diaminoanthraquinone; 9,9′-bis(4-aminophenyl fluorene); p,p′-4,4 bis(aminophenoxy); 5,5′-diamino-2,2′-bipyridylsuifide; 2,4-diaminoisopropyl benzene; 1,3-diaminobenzene (MPD); 2,2′-bis(trifluoromethyl)benzidene; 4,4′-diaminobiphenyl; 4,4′-diaminodiphenyl sulfid; 9,9′-bis(4-amino)fluorine; and mixtures thereof. In one embodiment the organic diamine is 3,4′-oxydianiline, 1,3-bis-(4-aminophenoxyl)benzene, 4,4′-oxydianiline, 1,4-diaminobenzene, 1,3-diaminobenzene, 2,2′-bis(trifluoromethyl)benzidene, 4,4′-diaminobiphenyl, 4,4′-diaminodiphenyl sulfide, 9,9′-bis(4-amino)fluorine or mixtures thereof.

In one embodiment the aromatic dianhydride is pyromellitic dianhydride (PMDA), and the aromatic diamine is oxydianiline.

In one embodiment, the polyamic acid is derived from at least 50, or at least 75, or at least 90 mole percent of aromatic dianhydride, based upon the total dianhydride content of the polyimide precursor. In another embodiment the polyamic acid is derived from at least 50, or at least 75, or at least 90 mole percent of an aromatic diamine, based upon a total diamine content of the polyimide precursor.

Any suitable aprotic polar solvent can be used in the synthesis of polyamic acid. A suitable organic solvent acts as a solvent for the polyamic acid and at least one of the reactants. A suitable solvent is inert to the reactants. In one embodiment, the solvent is a solvent for polyamic acid and both the dianhydride and the diamine. The normally liquid organic solvents of the N,N-dialkylcarboxylamide class are useful as solvents in the process of this invention. Exemplary solvents include, but are not limited to, N,N-dimethylformamide and N,N-dimethylacetamide (DMAC), N,N-diethylformamide (DMF), N,N-diethylacetamide, N,N-dimethylmethoxyacetamide, N-methyl-2-pyrrolidone, N-methylcaprolactam, and the like. Other solvents which can be used are: dimethylsulfoxide, tetramethyl urea, pyridine, dimethylsulfone, hexamethylphosphoramide, tetramethylene sulfone, formamide, N-methylformamide, butyrolactone, and N-acetyl-2-pyrrolidone. The solvents can be used alone, in combinations of solvents, or in combination with other solvents such as aromatic hydrocarbons such as xylene and toluene, or ether containing solvents such as diglyme, propylene glycol methyl ether, propylene glycol, methyl ether acetate, and tetrahydrofuran.

The binder precursor composition described herein further comprises an electroactive material. In one embodiment, the electroactive material is a electroactive cathode material. In another embodiment the electroactive cathode material is a high voltage electroactive material, typically capable of being charged to greater than about 4.1 or about 4.2, or about 4.3, or about 4.35, or about 4.4, or about 4.5, or about 4.6, or about 4.7, or about 4.8 V vs. Li/Li⁺. Suitable cathode materials for a lithium ion battery include without limitation electroactive compounds comprising lithium and transition metals, such as LiCoO₂, LiNiO₂, LiMn₂O₄, LiCo_{0.2}Ni_{0.2}O₂ or LiV₃O₈;

LiₐCoG_{b}O₂ (0.90≦a≦1.8, and 0.001≦b≦0.1);

LiₐNi_{b}Mn_{c}Co_{d}RₑO_{2-f}Z_{f} where 0.8≦a≦1.2, 0.1≦b≦0.5, 0.2≦c≦0.7, 0.05≦d≦0.4, 0≦e≦0.2, b+c+d+e is about 1, and 0≦f≦0.08;

LiₐA_{1-b},R_{b}D₂ (0.90≦a≦1.8 and 0≦b≦0.5);

LiₐE_{1-b}R_{b}O_{2-c}D_{c} (0.90≦a≦1.8, 0≦b≦0.5 and 0≦c≦0.05);

LiₐNi_{1-b-c}Co_{b}R_{c}O_{2-d}Z_{d} where 0.9≦a≦1.8, 0≦b≦0.4, 0≦c≦0.05, and 0≦d≦0.05;

Li_{1+z}Ni_{1-x-y}CoₓAl_{y}O₂ where 0<x<0.3, 0<y<0.1, and 0<z<0.06;

LiNi_{0.5}Mn_{1.5}O₄; LiFePO₄, LiMnPO₄, LiCoPO₄, and LiVPO₄F.

In the above chemical formulas A is Ni, Co, Mn, or a combination thereof; D is O, F, S, P, or a combination thereof; E is Co, Mn, or a combination thereof; G is Al, Cr, Mn, Fe, Mg, La, Ce, Sr, V, or a combination thereof, R is Al, Ni, Co, Mn, Cr, Fe, Mg, Sr, V, Zr, Ti, a rare earth element, or a combination thereof; Z is F, S, P, or a combination thereof. Suitable cathodes include those disclosed in U.S. Pat. Nos. 5,962,166, 6,680,145, 6,964,828, 7,026,070, 7,078,128, 7,303,840, 7,381,496, 7,468,223, 7,541,114, 7,718,319, 7,981,544, 8,389,160, 8,394,534, and 8,535,832, and the references therein. By “rare earth element” is meant the lanthanide elements from La to Lu, and Y and Sc. In another embodiment the cathode material is an NMC cathode; that is, a LiNiMnCoO cathode. More specifically, cathodes in which the atomic ratio of Ni:Mn:Co is 1:1:1 (LiₐNi_{1-b-c}Co_{b}R_{c}O_{2-d}Z_{d} where 0.98≦a≦1.05, 0≦d≦0.05, b=0.333, c=0.333, where R comprises Mn) or where the atomic ratio of Ni:Mn:Co is 5:3:2 (LiₐNi_{1-b-c}Co_{b}R_{c}O_{2-d}Z_{d} where 0.98≦a≦1.05, 0≦d≦0.05, c=0.3, b=0.2, where R comprises Mn).

In another embodiment, the cathode in the lithium ion battery disclosed herein comprises a cathode active material exhibiting greater than 30 mAh/g capacity in the potential range greater than 4.6 V versus a Li/Li⁺ reference electrode. One example of such a cathode is a stabilized manganese cathode comprising a lithium-containing manganese composite oxide having a spinel structure as cathode active material. The lithium-containing manganese composite oxide in a cathode suitable for use herein comprises oxides of the formula LiₓNi_{y}M_{z}Mn_{2-y-z}O_{4-d}, wherein x is 0.03 to 1.0; x changes in accordance with release and uptake of lithium ions and electrons during charge and discharge; y is 0.3 to 0.6; M comprises one or more of Cr, Fe, Co, Li, Al, Ga, Nb, Mo, Ti, Zr, Mg, Zn, V, and Cu; z is 0.01 to 0.18; and d is 0 to 0.3. In one embodiment in the above formula, y is 0.38 to 0.48, z is 0.03 to 0.12, and d is 0 to 0.1. In one embodiment in the above formula, M is one or more of Li, Cr, Fe, Co and Ga. Stabilized manganese cathodes may also comprise spinel-layered composites which contain a manganese-containing spinel component and a lithium rich layered structure, as described in U.S. Pat. No. 7,303,840.

In another embodiment, the cathode in the lithium battery disclosed herein comprises a composite material represented by the structure of Formula:

x(Li_{2-w}A₁₋ᵥQ_{w+v}O₃₋ₑ)*(1−x)(Li_{y}Mn_{2-z}M_{z}O_{4-d})

wherein:

x is about 0.005 to about 0.1;

A comprises one or more of Mn or Ti;

Q comprises one or more of Al, Ca, Co, Cr, Cu, Fe, Ga, Mg, Nb, Ni, Ti, V, Zn, Zr or Y;

e is 0 to about 0.3;

v is 0 to about 0.5.

w is 0 to about 0.6;

M comprises one or more of Al, Ca, Co, Cr, Cu, Fe, Ga, Li, Mg, Mn, Nb, Ni, Si, Ti, V, Zn, Zr or Y;

d is 0 to about 0.5;

y is about 0 to about 1; and

z is about 0.3 to about 1; and

wherein the Li_{y}Mn_{2-z}M_{z}O_{4-d} component has a spinel structure and the Li_{2-w}Q_{w+v}A₁₋ᵥO₃₋ₑ component has a layered structure.

Other examples are layered-layered high-capacity oxygen-release cathodes such as those described in U.S. Pat. No. 7,468,223 charged to upper charging potentials above 4.5 V.

An electroactive material suitable for use herein can be prepared using methods such as the hydroxide precursor method described by Liu et al (J. Phys. Chem. C 13:15073-15079, 2009). In that method, hydroxide precursors are precipitated from a solution containing the required amounts of manganese, nickel and other desired metal(s) acetates by the addition of KOH. The resulting precipitate is oven-dried and then fired with the required amount of LiOH.H₂O at about 800 to about 950° C. in oxygen for 3 to 24 hours, as described in detail in the Examples herein. Alternatively, the cathode active material can be prepared using a solid phase reaction process or a sol-gel process as described in U.S. Pat. No. 5,738,957 (Amine).

Also disclosed herein are cathodes comprising the binder precursor composition. A cathode, comprising the electroactive cathode material, suitable for use herein may be prepared by methods such as mixing an effective amount of the cathode active material (e.g. about 70 wt % to about 97 wt %, or up to about 99 wt %), and a conductive substance, such as carbon, in a suitable solvent, such as N-methylpyrrolidone, to generate a paste, which is then coated onto a current collector such as aluminum foil, and dried to form the cathode. The binder precursor composition can optionally be calendared after it is applied to the current collector, either before or after it is imidized, as described below.

In one embodiment the cathode comprises an imidized form of the binder precursor composition. Imidization can be performed by any suitable method, such as thermal, chemical, or a combination of methods. Imidization methods are discussed in Polyimides (Encyclopedia Of Polymer Science and Technology, op. cit.), and the Handbook of Composite Reinforcements, Stuart M. Lee editor, 1993, pages 508-524. Typically it is performed thermally by heating the composition using any suitable technique, such as, heating in a convection oven, vacuum oven, infra-red oven in air or in inert atmosphere such as argon or nitrogen. The heating can be done step wise as done in a batch process or be done in a continuous process, where the sample can experience a temperature gradient. Typically the composition is first heated at a lower temperature to remove any solvent, then increased to the imidization temperature and held until imidization is sufficiently complete. The imidized form of the binder precursor composition may be fully or partially imidized; that is, the imidization may be stopped at any point to yield a cathode comprising a mixture of the imidized form and unimidized form of the binder precursor composition. In one embodiment, the imidization is stopped at a point where at least 50%, at least 70%, at least 90%, or at least 99%, imidization has occurred. Imidization temperature is dependent on the polyamic acid but is typically at least 300° C., or at least 350° C., or at least 400° C. The total heating time can be from 5 minutes to 2 hours. The acid sites which can be present in the unimidized or partially imidized binder precursor composition derived from the polyamic acid can optionally be exchanged with cations such as lithium. For instance, the cathode containing the binder can be contacted with a solution of lithium salt, preferably a nonaqueous solution, rinsed and then dried at elevated temperatures to remove any residual solvents from the polyamic precursor and the cation exchange solution.

In a typical procedure, the cathode containing the partially imidized or unimidized binder is immersed in a 0.25 M solution of lithium acetate in ethanol. After contacting the cathode with an excess of this solution for approximately 90 minutes at room temperature, it is rinsed with solvent and is thoroughly dried at 150 C in a vacuum drying oven for 18 hours. Following this drying procedure, the cathode immediately transferred to an inert atmosphere drybox.

Also disclosed herein is an electrochemical cell comprising:

(a) a housing;

(b) an anode and a cathode comprising the binder precursor composition described herein, disposed in the housing and in ionically conductive contact with one another;

(c) an electrolyte composition disposed in the housing and providing an ionically conductive pathway between the anode and the cathode; and

(d) a porous separator between the anode and the cathode

In one embodiment, the electrochemical cell is a lithium battery.

The housing of the electrochemical cell may be any suitable container to house the electrochemical cell components described above. Such a container may be fabricated in the shape of small or large cylinder, a prismatic case or a pouch.

An electrochemical cell as disclosed herein further contains an anode, which comprises an anode electroactive material. When the electrochemical cell is a lithium battery, the anode electroactive material is capable of storing and releasing lithium ions. Examples of suitable anode active materials include without limitation lithium alloys such as lithium-aluminum alloy, lithium-lead alloy, lithium-silicon alloy, lithium-tin alloy and the like; carbon materials such as graphite and mesocarbon microbeads (MCMB); phosphorus-containing materials such as black phosphorus, MnP₄ and CoP₃; metal oxides such as SnO₂, SnO and TiO₂; nanocomposites containing antimony or tin, for example nanocomposite containing antimony, oxides of aluminum, titanium, or molybdenum, and carbon, such as those described by Yoon et al (Chem. Mater. 21, 3898-3904, 2009); and lithium titanates such as Li₄Ti₅O₁₂ and LiTi₂O₄. In one embodiment, the anode active material is lithium titanate or graphite.

An anode can be made by a method similar to that described above for a cathode wherein, for example, a binder such as a vinyl fluoride-based copolymer is dissolved or dispersed in an organic solvent or water, which is then mixed with the active, conductive material to obtain a paste. The paste is coated onto a metal foil, preferably aluminum or copper foil, to be used as the current collector. The paste is dried, preferably with heat, so that the active mass is bonded to the current collector. Suitable anode active materials and anodes are available commercially from companies such as Hitachi NEI Inc. (Somerset, N.J.), and Farasis Energy Inc. (Hayward, Calif.).

An electrochemical cell as described herein also contains a porous separator between the anode and cathode. The porous separator serves to prevent short circuiting between the anode and the cathode. The porous separator typically consists of a single-ply or multi-ply sheet of a microporous polymer such as polyethylene, polypropylene, polyamide or polyimide, or a combination thereof. The pore size of the porous separator is sufficiently large to permit transport of ions to provide ionically conductive contact between the anode and cathode, but small enough to prevent contact of the anode and cathode either directly or from particle penetration or dendrites which can from on the anode and cathode. Examples of porous separators suitable for use herein are disclosed in U.S. Patent Application Publication No. 2012/0149852.

An electrochemical cell as described herein further contains a liquid electrolyte comprising an organic solvent and a lithium salt soluble therein. The lithium salt can be LiPF₆, LiBF₄, or LiClO₄. Typically, the organic solvent comprises one or more alkyl carbonates. In a further embodiment, the one or more alkyl carbonates comprises a mixture of ethylene carbonate and dimethylcarbonate. The optimum range of salt and solvent concentrations may vary according to specific materials being employed, and the anticipated conditions of use; for example, according to the intended operating temperature. In one embodiment, the solvent is 70 parts by volume ethylene carbonate and 30 parts by volume dimethyl carbonate, and the salt is LiPF₆.

Alternatively, the electrolyte may comprise a lithium salt such as, lithium hexafluoroarsenate, lithium bis-trifluoromethyl sulfonamide, lithium bis(oxalate)boronate, lithium difluorooxalatoboronate, or the Li⁺ salt of polyfluorinated cluster anions, or combinations of these. Alternatively, the electrolyte may comprise a solvent, such as optionally fluorinated carbonates, esters, ethers, or trimethylsilane derivatives of ethylene glycol or poly(ethylene glycols) or combinations of these. Additionally, the electrolyte may contain various additives known to enhance the performance or stability of Li-ion batteries, as reviewed for example by K. Xu in Chem. Rev., 104, 4303 (2004), and S. S. Zhang in J. Power Sources, 162, 1379 (2006).

Suitable electrolyte compositions can include fluorinated acyclic carboxylic acid esters, represented by the formula R¹—COO—R², where R¹ and R² independently represent an alkyl group, the sum of carbon atoms in R¹ and R² is 2 to 7, at least two hydrogens in R¹ and/or R² are replaced by fluorines and neither R¹ nor R² contains a FCH₂ or FCH group. Examples of suitable fluorinated acyclic carboxylic acid esters include without limitation CH₃—COO—CH₂CF₂H (2,2-difluoroethyl acetate, CAS No. 1550-44-3), CH₃—COO—CH₂CF₃ (2,2,2-trifluoroethyl acetate, CAS No. 406-95-1), CH₃CH₂—COO—CH₂CF₂H (2,2-difluoroethyl propionate, CAS No. 1133129-90-4), CH₃—COO—CH₂CH₂CF₂H (3,3-difluoropropyl acetate), CH₃CH₂—COO—CH₂CH₂CF₂H (3,3-difluoropropyl propionate), and HCF₂—CH₂—CH₂—COO—CH₂CH₃ (ethyl 4,4-difluorobutanoate, CAS No. 1240725-43-2). In one embodiment, the fluorinated acyclic carboxylic acid ester is 2,2-difluoroethyl acetate (CH₃—COO—CH₂CF₂H).

Suitable electrolyte compositions can include fluorinated acyclic carbonates are represented by the formula R³—OCOO—R⁴, where R³ and R⁴ independently represent an alkyl group, the sum of carbon atoms in R³ and R⁴ is 2 to 7, at least two hydrogens in R³ and/or R⁴ are replaced by fluorines and neither R³ nor R⁴ contains a FCH₂ or FCH group. Examples of suitable fluorinated acyclic carbonates include without limitation CH₃—OC(O)O—CH₂CF₂H (methyl 2,2-difluoroethyl carbonate, CAS No. 916678-13-2), CH₃—OC(O)O—CH₂CF₃ (methyl 2,2,2-trifluoroethyl carbonate, CAS No. 156783-95-8), CH3-OC(O)O—CH₂CF₂CF₂H (methyl 2,2,3,3-tetrafluoropropyl carbonate, CAS No. 156783-98-1), HCF₂CH₂—OCOO—CH₂CH₃ (ethyl 2,2-difluoroethyl carbonate, CAS No. 916678-14-3), and CF₃CH₂—OCOO—CH₂CH₃ (ethyl 2,2,2-trifluoroethyl carbonate, CAS No. 156783-96-9).

Suitable electrolyte compositions can include fluorinated acyclic ethers are represented by the formula: R⁵—O—R⁶, where R⁵ and R⁶ independently represent an alkyl group, the sum of carbon atoms in R⁵ and R⁶ is 2 to 7, at least two hydrogens in R⁵ and/or R⁶ are replaced by fluorines and neither R⁵ nor R⁶ contains a FCH₂ or FCH group. Examples of suitable fluorinated acyclic ethers include without limitation HCF₂CF₂CH₂—O—CF₂CF₂H (CAS No. 16627-68-2) and HCF₂CH₂—O—CF₂CF₂H (CAS No. 50807-77-7).

A mixture of two or more of these fluorinated acyclic carboxylic acid ester, fluorinated acyclic carbonate, and/or fluorinated acyclic ether solvents may also be used. Other suitable mixtures can include anhydrides. One suitable mixture includes a fluorinated acyclic carboxylic acid ester, ethylene carbonate, and maleic anhydride, such as 2,2-difluoroethey acetate, ethylene carbonate, and maleic anhydride. The electrolyte composition can comprise about 61% 2,2-difluoroethyl acetate, about 26% ethylene carbonate, and about 1% maleic anhydride by weight of the total electrolyte composition.

Suitable electrolyte compositions can also include organic carbonates. Suitable organic carbonates include fluoroethylene carbonate, ethylene carbonate, ethyl methyl carbonate, difluoroethylene carbonate isomers, trifluoroethylene carbonate isomers, tetrafluoroethylene carbonate, dimethyl carbonate, diethyl carbonate, propylene carbonate, vinylene carbonate, 2,2,3,3-tetrafluoropropyl methyl carbonate, bis(2,2,3,3-tetrafluoropropyl) carbonate, bis(2,2,2-trifluoroethyl) carbonate, 2,2,2-trifluoroethyl methyl carbonate, bis(2,2-difluoroethyl) carbonate, 2,2-difluoroethyl methyl carbonate, dipropyl carbonate, methyl propyl carbonate, ethyl propyl vinylene carbonate, methyl butyl carbonate, ethyl butyl carbonate, propyl butyl carbonate, dibutyl carbonate, vinylethylene carbonate, dimethylvinylene carbonate, or methyl 2,3,3-trifluoroallyl carbonate, or mixtures thereof.

The organic carbonate can be a non-fluorinated carbonate. One or more non-fluorinated carbonates or a mixture of one or more organic carbonate with one or more non-fluorinated carbonate may be used in the electrolyte composition. Suitable non-fluorinated carbonates include ethylene carbonate, ethyl methyl carbonate, dimethyl carbonate, diethyl carbonate, vinylene carbonate, di-tert-butyl carbonate, vinylethylene carbonate, dimethylvinylene carbonate, or propylene carbonate, or mixtures thereof, or ethylene carbonate, ethyl methyl carbonate, dimethyl carbonate, diethyl carbonate, vinylene carbonate, or propylene carbonate, or mixtures thereof.

Other suitable electrolyte compositions can also include a sulfate.

Suitable sulfates include cyclic sulfates represented by the formula:

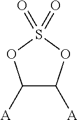

wherein each A is independently a hydrogen or an optionally fluorinated vinyl, allyl, acetylenic, or propargyl group.

Suitable electrolyte composition can also include lithium bis(oxalate)borate, lithium difluorooxalatoborate, lithium tetrafluoroborate or other lithium borate salts, or mixtures thereof.

The electrolyte compositions described herein can also contain at least one electrolyte salt. Suitable electrolyte salts include without limitation

lithium hexafluorophosphate (LiPF₆),

lithium tris(pentafluoroethyl)trifluorophosphate (LiPF₃(C₂F₅)₃),

lithium bis(trifluoromethanesulfonyl)imide,

lithium bis(perfluoroethanesulfonyl)imide,

lithium (fluorosulfonyl) (nonafluorobutanesulfonyl)imide,

lithium bis(fluorosulfonyl)imide,

lithium tetrafluoroborate,

lithium perchlorate,

lithium hexafluoroarsenate,

lithium trifluoromethanesulfonate,

lithium tris(trifluoromethanesulfonyl)methide,

lithium bis(oxalato)borate,

lithium difluoro(oxalato)borate,

Li₂B₁₂F₁₂₋ₓHₓ where x is equal to 0 to 8, and

mixtures of lithium fluoride and anion receptors such as B(OC₆F₅)₃.

Mixtures of two or more of these or comparable electrolyte salts may also be used. A suitable electrolyte salt is lithium hexafluorophosphate. The electrolyte salt can be present in the electrolyte composition in an amount of about 0.2 to about 2.0 M, or about 0.3 to about 1.5 M, or about 0.5 to about 1.2 M.

Suitable electrolyte compositions can additionally or optionally comprise additives that are known to those of ordinary skill in the art to be useful in conventional electrolyte compositions, particularly for use in lithium ion batteries. For example, electrolyte compositions disclosed herein can also include gas-reduction additives which are useful for reducing the amount of gas generated during charging and discharging of lithium ion batteries. Gas-reduction additives can be used in any effective amount, but can be included to comprise from about 0.05 weight % to about 10 weight %, alternatively from about 0.05 weight % to about 5 weight % of the electrolyte composition, or alternatively from about 0.5 weight % to about 2 weight % of the electrolyte composition.

Suitable gas-reduction additives that are known conventionally are, for example: halobenzenes such as fluorobenzene, chlorobenzene, bromobenzene, iodobenzene, or haloalkylbenzenes; 1,3-propane sultone; succinic anhydride; ethynyl sulfonyl benzene; 2-sulfobenzoic acid cyclic anhydride; divinyl sulfone; triphenylphosphate (TPP); diphenyl monobutyl phosphate (DMP); γ-butyrolactone; 2,3-dichloro-1,4-naphthoquinone; 1,2-naphthoquinone; 2,3-dibromo-1,4-naphthoquinone; 3-bromo-1,2-naphthoquinone; 2-acetylfuran; 2-acetyl-5-methylfuran; 2-methyl imidazolel-(phenylsulfonyl)pyrrole; 2,3-benzofuran; fluoro-cyclotriphosphazenes such as 2,4,6-trifluoro-2-phenoxy-4,6-dipropoxy-cyclotriphosphazene and 2,4,6-trifluoro-2-(3-(trifluoromethyl)phenoxy)-6-ethoxy-cyclotriphosphazene; benzotriazole; perfluoroethylene carbonate; anisole; diethylphosphonate; fluoroalkyl-substituted dioxolanes such as 2-trifluoromethyldioxolane and 2,2-bistrifluoromethyl-1,3-dioxolane; trimethylene borate; dihydro-3-hydroxy-4,5,5-trimethyl-2(3H)-furanone; dihydro-2-methoxy-5,5-dimethyl-3(2H)-furanone; dihydro-5,5-dimethyl-2,3-furandione; propene sultone; diglycolic acid anhydride; di-2-propynyl oxalate; 4-hydroxy-3-pentenoic acid γ-lactone; CF₃COOCH₂C(CH₃) (CH₂OCOCF₃)₂; CF₃COOCH₂CF₂CF₂CF₂CF₂CH₂OCOCF₃; α-methylene-γ-butyrolactone; 3-methyl-2(5H)-furanone; 5,6-dihydro-2-pyranone; diethylene glycol, diacetate; triethylene glycol dimethacrylate; triglycol diacetate; 1,2-ethanedisulfonic anhydride; 1,3-propanedisulfonic anhydride; 2,2,7,7-tetraoxide 1,2,7-oxadithiepane; 3-methyl-, 2,2,5,5-tetraoxide 1,2,5-oxadithiolane; hexamethoxycyclotriphosphazene; 4,5-dimethyl-4,5-difluoro-1,3-dioxolan-2-one; 2-ethoxy-2,4,4,6,6-pentafluoro-2, 2,4,4,6,6-hexahydro-1,3,5,2,4,6-triazatriphosphorine; 2,2,4,4,6-pentafluoro-2,2,4,4,6,6-hexahydro-6-methoxy-1,3,5,2,4,6-triazatriphosphorine; 4,5-difluoro-1,3-dioxolan-2-one; 1,4-bis(ethenylsulfonyl)-butane; bis(vinylsulfonyl)-methane; 1,3-bis(ethenylsulfonyl)-propane; 1,2-bis(ethenylsulfonyl)-ethane; and 1,1′-[oxybis(methylenesulfonyl)]bis-ethene.

Other suitable additives that can be used are HF scavengers, such as silanes, silazanes (Si—NH—Si), epoxides, amines, aziridines (containing two carbons), salts of carbonic acid such as lithium oxalate, B₂O₅, ZnO, and fluorinated inorganic salts.

The electrochemical cell or lithium ion battery disclosed herein may be used for grid storage or as a power source in various electronically-powered or -assisted devices (“electronic device”) such as a transportation device (including a motor vehicle, automobile, truck, bus or airplane), a computer, a telecommunications device, a camera, a radio or a power tool.

The cathode as described above can be prepared via the method below. Described herein is a method to prepare a cathode of an electrochemical cell, comprising the steps of:
(a) combining a polyamic acid that has an anhydride to amine ratio of greater than or equal to about 0.985:1 to less than or equal to about 1.10:1 with a solvent and an electroactive material to form a binder precursor mixture; and
(b) applying the binder precursor mixture to a cathode current collector plate.

The polyamic acid is as described above. The cathode current collector is a material which receives electrons from the external circuit. It can be of any suitable material, size, or shape, but is typically a metal grid or sheet. Suitable materials for current collectors are described in Journal of The Electrochemical Society, 152, 11, A2105-A2113, 2005.

The method can additionally comprise:
(c) imidizing the binder precursor mixture.

The imidization can be performed by any suitable method, as described above, and can be partial or complete. Typically it is performed thermally by heating the composition using any suitable technique. The binder precursor composition can optionally be calendared after it is applied to the current collector, either before or after it is imidized, as described below.

### EXAMPLES

The meaning of abbreviations used is as follows: “g” means gram(s), “mg” means milligram(s), “μg” means microgram(s), “L” means liter(s), “mL” means milliliter(s), “mol” means mole(s), “mmol” means millimole(s), “M” means molar concentration, “wt %” means percent by weight, “mm” means millimeter(s), “ppm” means parts per million, “h” means hour(s), “min” means minute(s), “mA” mean milliamp(s), “mAh/g” mean milliamp hour(s) per gram, “V” means volt(s), “Pa” means pascal(s), “kPa” means kilopascal(s), “rpm” means revolutions per minute, “psi” means pounds per square inch, “NMR” means nuclear magnetic resonance spectroscopy, “GC/MS” means gas chromatography/mass spectrometry.

### Half Cell (Potential Step Measurements)

### Comparative Example A

### Preparation of Electrode

An electrode containing carbon and polyvinylidene difluoride binder was prepared on 1 mil Aluminum foil. 0.3614 grams of carbon black (acetylene black, uncompressed, Denka Corp., New York, N.Y.) was added to a 20 mL vial, followed by 6.7399 grams of n-methylpyrrolidone (Aldrich, St. Louis, Mo.). 0.7086 grams of PVDF solution (13 wt % polyvinylidene difluoride (Kureha America Inc., New York, N.Y., KFL#1120) was added to the mixture. After closing the vial, it was mixed in a THINKY centrifugal mixture ((THINKY ARE-310, THINKY Corp., Japan)) for 2 minutes at 2000 RPM. An additional 3.0900 grams of n-methylpyrrolidone (Aldrich, St. Louis, Mo.) was added to the mixture.

1.2103 grams of n-methylpyrrolidone was added and the mixture was then homogenized using a shear mixer (IKA® Works, Wilmington, N.C.) for 5 minutes at 20,000 rpm. Following homogenization, the paste mixed with a THINKY centrifugal mixer again for 2 minutes at 2000 RPM to get the final paste.

The paste was cast on 1 mil Al foil (All Foils Inc., Cleveland, Ohio) using an automatic film coater (AFA-II, MTI Corp, Richmond, Calif.). The electrode was prepared using a 10 mil doctor blade with an additional 2 mil thick Kapton® polyimide film tape to produce a final gate clearance of 12 mils. The paste was dried in a FDL115 convection oven (BINDER Inc., Bohemia, N.Y.) by heating to 100° C. (ramped from 85° C. to 100° C. for 15 minutes and held at 100° C. for 15 minutes). The final electrode width was 2 inches (50.8 mm) in width, and is calendared using a laminator, which consists of two steel rolls with a diameter of 100 mm. The electrode was placed between two brass shims that are about 178 μm thick and passed through the laminator at a temperature of 125° C., and pressures of 9 psi, 12 psi, and 15 psi, as measured by a pressure gauge which reads the air pressure to the pistons to control the force of the device. The total nip force of the laminator in kg is equivalent to a factor of 17.1 multiplied by the regulator pressure in psi. The average thickness of the electrode was 1.21 mil (not including the aluminum foil).

The electrode was punched out into a 9/16″ (14.29 mm) disc and placed into a vial. This was placed into a heating box in an antechamber of an inert argon dry box to be further dried at 90° C. under vacuum at −25 inches of Hg (−85 kPa) for 6 hours. The antechamber was restored to atmospheric pressure with Argon and the samples were brought into the inert Argon dry box.

### Preparation of Coin Cells—Carbon/Li Half Cells

In argon filled drybox, the 80 wt % modified carbon, 20 wt % binder electrode, prepared as described above, were weighed and used in coin cells. Three coin cells were prepared in this manner. The final loading of the carbon-binder electrode was approximately 2 mg). Polypropylene gaskets were placed into an aluminum clad 2032 stainless steel can, followed by the modified carbon electrode. Approximately 4 drops of an electrolyte consisting of 70 vol % ethylmethyl carbonate, 30 vol % ethylene carbonate, and 1.0 M LiPF6 (Novolyte, Cleveland, Ohio) were added to the cell, followed by two Celgard® 2325 separators (Celgard, LLC. Charlotte, N.C.), an additional 3 drops of electrolyte, a lithium foil anode (14.5 mm diameter×250 μm in thickness; Rockwood Lithium Inc., Kings Mountain, N.C.), a 16.0 mm×0.3 mm stainless steel spacer, a 16.0 mm×1.0 mm stainless steel spacer, and a Hoshen wave spring (15 mm×1.4 mm). A 2032 stainless steel cap (Hohsen, Corp. Japan) was then used to form the Carbon/Li half-cell. The coin cell was then crimped for 5 seconds using a Hoshen 5GU7-5RH crimper.

### Example 1

The same procedures were used as described in Comparative Example A, except that PVDF was not used as the binder for this electrode.

To prepare the polyamic acid, a prepolymer was first prepared. 20.6 wt % of PMDA:ODA prepolymer was prepared using a stoichiometry of 0.98:1 PMDA/ODA (pyromellitic dianhydride/ODA (4,4′-diaminodiphenyl ether) prepolymer). This was prepared by dissolving ODA in dimethylacetamide (DMAC) over the course of approximately 45 minutes at room temperature with gentle agitation. PMDA powder was slowly added (in small aliquots) to the mixture to control any temperature rise in the solution; the addition of the PMDA was performed over approximately two hours. The addition and agitation of the resulting solution under controlled temperature conditions was performed until a viscosity of approximately 75 poise was achieved. The final concentration of the polyamic acid was 20.6 wt % and the molar ratio of the anhydride to the amine component was approximately 0.98:1.

In a separate container, a 6 wt % solution of pyromellitic anhydride (PMDA) was prepared by combining 1.00 g of PMDA (Aldrich 412287, Allentown, Pa.) and 15.67 g of DMAc (dimethylacetamide). 4.7 grams of the PMDA solution was slowly added to the prepolymer and the viscosity was increased to approximately 36,000 poise (as measured by a Brookfield viscometer—#6 spindle). This resulted in a finished prepolymer solution in which the calculated final PMDA:ODA ratio was 1.01:1.

22.0 grams of the finished prepolymer was then diluted with 70.0 grams of DMAc to create a 4.7 wt % binder solution.

To a 20 ml vial, 1.49 g of the binder solution was mixed with 2.62 grams of DMAc (dimethylacetamide) solvent. It was mixed on the THINKY centrifugal mixer for 2 minutes at 2000 rpm. An additional 0.28 grams of Denka carbon and 2.62 grams of DMAc was then added, and the mixture mixed for an additional 2 minutes at 2000 rpm.

The ink formulation was then homogenized at 9500 rpm for 5 minutes using a homogenizer (Polytron PT 10-35GT with blade#GENERATOR 20 MM PT-DA3020/2EC).

The ink was cast onto Aluminum foil (1 mil). A 10 mil doctor blade was used to cast the formulation. 2 mils of Kapton® polyimide film tape was used for a 12 mil gate opening.

The electrode was calendered at 125° C. (as in Comparative Example A) and thermally imidized according to the following protocol in a Thermolyne, F6000 box furnace purged with nitrogen gas.

40° C. to 125° C. (ramped at 4° C./min)

125° C. to 125° C. (30 min)

125° C. to 250° C. (ramp at 4° C./min)

250° C. to 250° C. (soak 30 min)

250° C. to 400° C. (ramp at 5 c/min)

400° C. to 400° C. (soak 20 min)

### Example 2

The same procedures were used as described in Example 1, except that the electrode was thermally imidized and then calendered.

To a 20 ml vial, 0.4 g of the binder solution described above was mixed with 3.82 grams of DMAc (dimethylacetamide) solvent. It was mixed on the THINKY centrifugal mixer for 2 minutes at 2000 rpm. An additional 0.34 grams of Denka carbon and 3.82 grams of DMAc was then added, and the mixture mixed for an additional 2 minutes at 2000 rpm.

The ink formulation was then homogenized at 9500 rpm for 5 minutes using a homogenizer (Polytron PT 10-35GT with blade#GENERATOR 20 MM PT-DA3020/2EC).

The ink was cast onto Aluminum foil (1 mil). A 10 mil doctor blade was used to cast the formulation. 2 mils of Kapton® polyimide film tape was used for a 12 mil gate opening.

The electrode was calendered at 125° C. (as described in Comparative Example A) and subsequently thermally imidized according to the protocol described in Example 1 in a Thermolyne, F6000 box furnace purged with nitrogen gas.

### Example 3

The same procedures were used as described in Comparative Example A, except that PVDF was not used as the binder for this electrode.

To prepare the polyamic acid, a prepolymer was first prepared with a 1:0.98 stochiometry of PMDA:ODA (20.6 wt % in DMAc. In a 500 ml round bottom flask, 226.5 grams of DMAc was combined with 29.43 g of ODA and stirred for 10 minutes at room temperature. 32.7 g of PMDA powder was slowly added to the solution to control the temperature of the resulting solution to 40° C. or less. 13.03 grams of DMAc was then added and the resultant mixture was slowly stirred until the solid was dissolved. The entire mixture was stirred overnight under a nitrogen atmosphere blanket.). The final PMDA:ODA ratio was calculated as 1.02:1.

To a 20 ml vial, 0.4 g of the binder solution described above was mixed with 3.82 grams of DMAc solvent. It was mixed on the THINKy centrifugal mixer for 2 minutes at 2000 rpm. An additional 0.34 grams of Denka carbon and 3.82 grams of DMAc was then added, and the mixture mixed for an additional 2 minutes at 2000 rpm.

The ink formulation was then homogenized at 9500 rpm for 5 minutes using a homogenizer (Polytron PT 10-35GT with blade#GENERATOR 20 MM PT-DA3020/2EC).

The ink was cast onto Aluminum foil (1 mil). A 10 mil doctor blade was used to cast the formulation. 2 mils of Kapton® polyimide film tape was used for a 12 mil gate opening.

### Example 4

The same procedures were used as described in Example 4, except for the following differences.

The electrode was thermally imidized according to the protocol described in Example 1 in a Thermolyne, F6000 box furnace purged with nitrogen gas and then calendered at 125° C. (as described in Comparative Example A).

### Comparative Example B

The same procedures were used as described in Example 1, except for the following differences:

Polyamic acid with a stoichiometry of 0.98:1 PMDA/ODA was used as the binder for the electrode. To a 20 ml vial, 0.4 g of the binder solution described above was mixed with 3.82 grams of DMAc (dimethylacetamide) solvent. It was mixed on the THINKY centrifugal mixer for 2 minutes at 2000 rpm. An additional 0.34 grams of Denka carbon and 3.82 grams of DMAc was then added, and the mixture mixed for an additional 2 minutes at 2000 rpm.

The ink formulation was then homogenized at 9500 rpm for 5 minutes using a homogenizer (Polytron PT 10-35GT with blade#GENERATOR 20 MM PT-DA3020/2EC).

### Half Cell Testing Results

A potential step electrochemical test was used to measure the electro oxidation of the electrolyte at high potentials. A Maccor 4000 series automated test system was used. All tests were performed at 55° C. The cell voltage (versus Li/Li⁰) was increased in 100 mV increments from 3.8 V to 5 V. The voltage was held constant at each potential step for 72 hours and the current was measured during that time. At 5 V, current after 72 hours are displayed in microamps in Table 1 below. The 5 V currents 72 hours and the average current (averaged from at least two coin cell measurements) is displayed. The current normalized to the amount of

TABLE 1

| | | Current | Current |
|---|---|---|---|
| | | (μA) at | (μA)/ |
| Example | Binder | 5.0 V, 72 hours | mg carbon |
| 1 | PMDA/ODA 1.01:1 | 8.94 | 5.28 |
| | calendared then thermally | | |
| | imidized | | |
| 2 | PMDA/ODA 1.01:1 | 9.60 | 5.10 |
| | thermally imidized then | | |
| | calendared | | |
| 3 | PMDA/ODA 1.02:1 | 7.82 | 5.79 |
| | unimidized and calendered | | |
| 4 | PMDA/ODA 1.02:1 | 8.01 | 6.32 |
| | thermally imidized then | | |
| | calendered | | |
| Comparative A | PVDF | 28.62 | 14.7 |
| Comparative B | PMDA/ODA 0.98:1 | 55.82 | 13.6 |

### Full Cell Measurements

### Comparative Example C

### Preparation of 2,2-Difluoroethyl Acetate

The 2,2-difluoroethyl acetate used in the following Examples was prepared by reacting potassium acetate with HCF₂CH₂Br. The following is a typical procedure used for the preparation.

Potassium acetate (Aldrich, Milwaukee, Wis., 99%) was dried at 100° C. under a vacuum of 0.5-1 mm of Hg (66.7-133 Pa) for 4 to 5 h. The dried material had a water content of less than 5 ppm, as determined by Karl Fischer titration. In a dry box, 212 g (2.16 mol, 8 mol % excess) of the dried potassium acetate was placed into a 1.0-L, 3 neck round bottom flask containing a heavy magnetic stir bar. The flask was removed from the dry box, transferred into a fume hood, and equipped with a thermocouple well, a dry-ice condenser, and an additional funnel.

Sulfolane (500 mL, Aldrich, 99%, 600 ppm of water as determined by Karl Fischer titration) was melted and added to the 3 neck round bottom flask as a liquid under a flow of nitrogen. Agitation was started and the temperature of the reaction medium was brought to about 100° C. HCF₂CH₂Br (290 g, 2 mol, E.I. du Pont de Nemours and Co., 99%) was placed in the addition funnel and was slowly added to the reaction medium. The addition was mildly exothermic and the temperature of the reaction medium rose to 120-130° C. in 15-20 min after the start of the addition. The addition of HCF₂CH₂Br was kept at a rate which maintained the internal temperature at 125-135° C. The addition took about 2-3 h. The reaction medium was agitated at 120-130° C. for an additional 6 h (typically the conversion of bromide at this point was about 90-95%). Then, the reaction medium was cooled down to room temperature and was agitated overnight. Next morning, heating was resumed for another 8 h.

At this point the starting bromide was not detectable by NMR and the crude reaction medium contained 0.2-0.5% of 1,1-difluoroethanol. The dry-ice condenser on the reaction flask was replaced by a hose adapter with a Teflon® valve and the flask was connected to a mechanical vacuum pump through a cold trap (−78° C., dry-ice/acetone). The reaction product was transferred into the cold trap at 40-50° C. under a vacuum of 1-2 mm Hg (133 to 266 Pa). The transfer took about 4-5 h and resulted in 220-240 g of crude HCF₂CH₂OC(O)CH₃ of about 98-98.5% purity, which was contaminated by a small amount of HCF₂CH₂Br (about 0.1-0.2%), HCF₂CH₂OH (0.2-0.8%), sulfolane (about 0.3-0.5%) and water (600-800 ppm). Further purification of the crude product was carried out using spinning band distillation at atmospheric pressure. The fraction having a boiling point between 106.5-106.7° C. was collected and the impurity profile was monitored using GC/MS (capillary column HP5MS, phenyl-methyl siloxane, Agilent19091S-433, 30.m, 250 μm, 0.25 μm; carrier gas—He, flow rate 1 mL/min; temperature program: 40° C., 4 min, temp. ramp 30° C./min, 230° C., 20 min). Typically, the distillation of 240 g of crude product gave about 120 g of HCF₂CH₂OC(O)CH₃ of 99.89% purity, (250-300 ppm H₂O) and 80 g of material of 99.91% purity (containing about 280 ppm of water). Water was removed from the distilled product by treatment with 3 A molecular sieves, until water was not detectable by Karl Fischer titration (i.e., <1 ppm).

### Preparation of LiMn_{1.5}Ni_{0.45}Fe_{0.05}O₄ Cathode Active Material

For the preparation of LiMn_{1.5}Ni_{0.45}Fe_{0.05}O₄, 401 g manganese (II) acetate tetrahydrate (Aldrich, Milwaukee Wis., Product No. 63537), 125 g nickel (II) acetate tetrahydrate (Aldrich, Product No. 72225) and 10 g iron (II) acetate anhydrous (Alfa Aesar, Ward Hill, Mass., Product No. 31140) were weighed into bottles on a balance, then dissolved in 5.0 L of deionized water. KOH pellets were dissolved in 10 L of deionized water to produce a 3.0 M solution inside a 30 L reactor. The solution containing the metal acetates was transferred to an addition funnel and dripped into the rapidly stirred reactor to precipitate the mixed hydroxide material. Once all 5.0 L of the metal acetate solution was added to the reactor, stirring was continued for 1 h. Then, stirring was stopped and the precipitate was allowed to settle overnight. After settling, the liquid was removed from the reactor and 15 L of fresh deionized water was added. The contents of the reactor were stirred, allowed to settle again, and the liquid was removed. This rinse process was repeated. Then, the precipitate was transferred to two (split evenly) coarse glass frit filtration funnels covered with Dacron® paper. The solids were rinsed with deionized water until the filtrate pH reached 6.0 (pH of deionized rinse water), and a further 20 L of deionized water was added to each filter cake. Finally, the cakes were dried in a vacuum oven at 120° C. overnight. The yield at this point was typically 80-90%.

The hydroxide precipitate was ground and mixed with lithium carbonate. This step was done in 50 g batches using a Pulverisette automated mortar and pestle (FRITSCH, Germany). For each batch the hydroxide precipitate was weighed, then ground alone for 5 min in the Pulveresette. Then, a stoichiometric amount with small excess of lithium carbonate was added to the system. For 50 g of hydroxide precipitate, 10.5 g of lithium carbonate was added. Grinding was continued for a total of 60 min with stops every 10-15 min to scrape the material off the surfaces of the mortar and pestle with a sharp metal spatula. If humidity caused the material to form clumps, it was sieved through a 40 mesh screen once during grinding, then again following grinding.

The ground material was fired in an air box furnace inside shallow rectangular alumina trays. The trays were 158 mm by 69 mm in size, and each held about 60 g of material. The firing procedure consisted of ramping from room temperature to 900° C. in 15 h, holding at 900° C. for 12 h, then cooling to room temperature in 15 h.

After firing, the powder was ball-milled to reduce particle size. Then, 54 g of powder was mixed with 54 g of isopropyl alcohol and 160 g of 5 mm diameter zirconia beads inside a polyethylene jar. The jar was then rotated on a pair of rollers for 6 h to mill. The slurry was separated by centrifugation, and the powder was dried at 120° C. to remove moisture.

### Cathode Preparation

The binder was obtained as a 12% solution of polyvinylidene fluoride in NMP (N-methylpyrrolidone, KFL No. 1120, Kureha America Corp. New York, N.Y.). The following materials were used to make an electrode paste: 2.1004 g LiMn_{1.5}Ni_{0.45}Fe_{0.05}O₄ cathode active powder as prepared above; 0.1718 g carbon black (Denka uncompressed, DENKA Corp., Japan); 1.4446 g PVDF (polyvinylidene difluoride) solution; and 1.4329 g+0.4319 g NMP (Sigma Aldrich). The materials were combined in a ratio of 86:7:7, cathode active powder: PVDF: carbon black, as described below. The final paste contained 44.37% solids.

The carbon black, the first portion of NMP, and the PVDF solution were first combined in a plastic vial and centrifugally mixed (ARE-310, Thinky USA, Inc., Laguna Hills, Calif.) for 2 minutes at 2000 rpm each time. The cathode active powder and the 2^{nd} portion of NMP were added and the paste was centrifugally mixed for 2 min at 2000 rpm. The vial was clamped and the rotor-stator shaft of a homogenizer (model PT 10-35 GT, 7.5 mm diameter stator, Kinematicia, Bohemia, N.Y.) was inserted into the vial. The resulting paste was homogenized for 5 minutes at 9500 rpm, periodically moving the position of the vial.

The paste was cast using doctor blades with a 0.41-0.51 mm gate height onto aluminum foil (25 μm thick, 1145-0, Allfoils, Brooklyn Heights, Ohio) using an automatic coater (AFA-II, MTI Corp., Richmond, Calif.). The electrode was dried in a mechanical convection oven (model FDL-115, Binder Inc., Great River, N.Y.) using a procedure with a 15 minute ramp from 80-100° C., followed by a hold of 15 minutes at 100° C. Loadings of cathode active material were 9 to 12 mg/cm². The final electrode width was approximately 2 inches (50.8 mm) in width, and is calendared using a laminator. This consists of two steel rolls with a diameter of 100 mm. The electrode was placed between two brass shims that are about 178 μm thick and passed through the laminator at ambient temperature, and pressures of 12 psi (0.08 MPa), 18 psi (0.12 MPa), 25 psi (0.17 MPa), and 28 psi (0.19 MPa) with two passes each, as measured by a pressure gauge which reads the air pressure to the pistons to control the force of the device. The total Nip Force of the laminator in kg is equivalent to a factor of 17.1 multiplied by the regulator pressure in psi.

### Anode Preparation

The following is a description of a representative preparation of an LTO anode. The LTO anode active material, Li₄Ti₅O₁₂ (NEI Nanomyte™ BE-10, Somerset, N.J.), was ground for ten minutes using an agate mortar and pestle. The ground anode active material (4.440 g), 0.555 g of Super P Li carbon (Timcal, Switzerland), 4.269 g of polyvinylidene difluoride (PVDF) solution (13 wt % in N-methylpyrrolidone (NMP), Kureha America Inc., New York, N.Y., KFL#1120), and an additional 5.736 g of NMP were mixed first using a planetary centrifugal mixer (THINKY ARE-310, THINKY Corp., Japan) at 2,000 rpm, a shear mixer (VWR, Wilmington, N.C.), and then a planetary centrifugal mixer at 2,000 rpm to form a uniform slurry. The slurry was coated on copper foil using a doctor blade, and dried first on a hot plate at 100° C. for five to seven minutes, then in a vacuum oven at 100° C. for five to seven minutes. The electrode and shims were covered with a second 125 mm thick brass sheet, and the assembly was passed through a calender three times using 100 mm diameter steel rolls heated to 125° C. with a nip force of 154, 205, and 356 kg, respectively.

### Coin Cells

Circular anodes with a 14.3 mm diameter and cathodes with a 12.7 mm diameter were punched out from the electrode sheets described above, placed in a heater in the antechamber of a glove box (Vacuum Atmospheres, Hawthorne, Calif., with HE-493 purifier), further dried under vacuum overnight at 90° C., and brought into an argon-filled glove box. The cathodes and anodes were chosen so that the ratio of weight of the active component on the cathode to the weight of the active component on the anode which overlaps the cathode, i.e., in the overlap region only, is approximately 0.80. Non-aqueous electrolyte lithium-ion CR2032 coin cells were prepared for electrochemical evaluation. The coin cell parts (case, spacers, wave spring, gasket, and lid) and coin cell crimper were obtained from Hohsen Corp (Osaka, Japan). The separator was a polyimide nanofiber (Energain®, E.I. du Pont de Nemours and Company, Wilmington, Del.).

### High Temperature Performance Full Cells

Full cells, containing the anode, cathode, and 2,2-difluoroethyl acetate nonaqueous electrolyte, were cycled using a commercial battery tester (Series 4000, Maccor, Tulsa, Okla.) in a temperature-controlled chamber at 55 OC using voltage limits of 1.9 to 3.4 V. The constant-current charge and discharge currents for the first two cycles were carried out at 120 mA/g of LNMO (about 1 C rate) for 24 cycles at room temperature and then subsequent cycles were carried out at 2 C at 55° C.

### Example 5

The same procedures were followed as described in Comparative Example C with the following differences.

To prepare the high molecular weight polyamic acid, 20.6 wt % of PMDA:ODA was prepared using a stoichiometry of 0.98:1 (PMDA/ODA-(pyromellitic dianhydride/ODA (4,4′-diaminodiphenyl ether) prepolymer).

In a separate container, a 6 wt % solution of pyromellitic anhydride (PMDA) was prepared by combining 1.00 g of PMDA (Aldrich 412287, Allentown, Pa.) and 15.67 g of DMAc. 4.7 grams of the PMDA solution was slowly added to the prepolymer and the viscosity was increased to approximately 36,000 poise (as measured by a Brookfield viscometer—#6 spindle P. Gardner corp. Pompano Beach Fl.). The final PMDA:ODA ratio was calculated to be approximately 1.01:1.

22.0 grams of finished prepolymer was then diluted with 70.0 grams of DMAc to create a 4.7 wt % binder solution. This was further diluted by taking 5.25 g of this finished polyamic acid and adding it to 10.445 g of DMAc to obtain a concentration of 0.065.

To a 20 ml vial, 0.154 g of Denka, 2.81 g binder, and 1.48 g of DMAc was added. It was mixed on the THINKY centrifugal mixer for 2 minutes at 2000 rpm. 2.26 g Fe-LNMO active and 0.27 grams of DMAc were then added, and the mixture mixed for an additional 2 minutes at 2000 rpm.

The mixture was then treated with a a Dukane 1000 Auto-track ultrasonic horn, model 41027 (St. Charles, Ill.) for 15-20 seconds using the low setting of the apparatus.

The paste was cast onto Aluminum foil (1 mil thick, 1145-0, Allfoils, Brooklyn Heights, Ohio). A 4 mil doctor blade was used to cast the formulation. 2 mils of Kapton® polyimide film tape was used for a 6 mil gate opening.

### Coin Cells

Circular anodes with a 14.3 mm diameter and cathodes with a 12.7 mm diameter were punched out from the electrode sheets described above, placed in a heater in the antechamber of a glove box (Vacuum Atmospheres, Hawthorne, Calif., with HE-493 purifier), further dried under vacuum overnight at 90 OC, and brought into an argon-filled glove box. The cathodes and anodes were chosen so that the ratio of weight of the active component on the cathode to the weight of the active component on the anode which overlaps the cathode, i.e., in the overlap region only, is approximately 0.95. Non-aqueous electrolyte lithium-ion CR2032 coin cells were prepared for electrochemical evaluation. The coin cell parts (case, spacers, wave spring, gasket, and lid) and coin cell crimper were obtained from Hohsen Corp (Osaka, Japan). The separator was a polyimide nanofiber (Energain®, E.I. du Pont de Nemours and Company, Wilmington, Del.).

### High Temperature Performance Full Cells

Full cells, containing the anode, cathode, and nonaqueous electrolyte shown in FIG. 1, were cycled using a commercial battery tester (Series 4000, Maccor, Tulsa, Okla.) in a temperature-controlled chamber at 55° C. using voltage limits of 1.9 to 3.4 V. The constant-current charge and discharge currents for the first two cycles were carried out at 120 mA/g of LNMO (about 1 C rate) for 24 cycles at room temperature and then subsequent cycles were carried out at 2 C at 55° C.

### Example 6

The same procedure as described in Example 3 was used, except for the following differences. The cathodes and anodes were chosen so that the ratio of weight of the active component on the cathode to the weight of the active component on the anode which overlaps the cathode, i.e., in the overlap region only, is approximately 0.75-0.8.

Electrochemical evaluations of the coin cells at 55° C. are shown in Table 2 below. At 900 cycles, the discharge capacity of Example 3 was 85 mAh/g (cell 1) and 72 mAh/g (cell 2). The discharge capacity of Example 4 at 900 cycles was 80 mAh/g and 69 mAh/g. This compares to the discharge capacities of Comparative Example C, where capacities of 68, 50 and 10 mAh/g are observed at 900 cycles.

TABLE 2

| | | Initial | | |
|---|---|---|---|---|
| | | Discharge | | |
| | | Capacity | | |
| | | Cycle 2, | Discharge | average |
| | | following | Capacity at | capacity |
| | | formation, | 900 cycles, | retention to |
| Example | Binder Type | mAh/g | mAh/g | 900 cycles |
| Comparative C, | PVDF | 114.0 | 67.0 | 59 |
| cell 1 | | | | |
| Comparative C, | PVDF | 104.0 | 49.0 | 47 |
| cell 2 | | | | |
| Comparative C, | PVDF | 98.0 | 9.0 | 9 |
| cell 3 | | | | |
| Average | — | 105.3 | 41.7 | 38 |
| Comparative C | | | | |
| Example 5, cell 1 | PMDA/ODA | 121.0 | 84.0 | 69 |
| | 1.01:1 | | | |
| Example 5, cell 2 | PMDA/ODA | 123.0 | 72.0 | 59 |
| | 1.01:1 | | | |
| Example 6, cell 1 | PMDA/ODA | 95.0 | 79.0 | 83 |
| | 1.01:1 | | | |
| Example 6, cell 2 | PMDA/ODA | 113.0 | 69.0 | 61 |
| | 1.01:1 | | | |
| Average | — | 113.0 | 76.0 | 68 |
| Example 5-6 | | | | |

What is claimed is:

1. A binder precursor composition for a cathode of an electrochemical cell comprising an electroactive cathode material and a polyamic acid, wherein the polyamic acid has an anhydride to amine ratio of greater than or equal to about 0.985:1 to less than or equal to about 1.10:1.

2. The binder precursor composition of claim 1 wherein the polyamic acid has an anhydride to amine ratio of greater than or equal to about 0.990:1 to less than or equal to about 1.01:1.

3. The binder precursor composition of claim 1 wherein the polyamic acid has an anhydride to amine ratio of greater than or equal to about 1.01:1 to less than or equal to about 1.03:1.

4. The binder precursor composition of claim 1 wherein the electroactive cathode material comprises a cathode active material exhibiting greater than 30 mAh/g capacity in the potential range greater than 4.6 V versus a Li/Li⁺ reference electrode.

5. The binder precursor composition of claim 1 wherein the electroactive cathode material comprises a cathode active material which is charged to a potential greater than or equal to 4.35 V versus a Li/Li⁺ reference electrode.

6. The binder precursor composition of claim 1 wherein the electroactive cathode material comprises a lithium-containing manganese composite oxide having a spinel structure as active material, the lithium-containing manganese composite oxide being represented by the formula:
LiₓNi_{y}M_{z}Mn_{2-y-z}O_{4-d},
wherein x is 0.03 to 1.0; x changes in accordance with release and uptake of lithium ions and electrons during charge and discharge; y is 0.3 to 0.6; M comprises one or more of Cr, Fe, Co, Li, Al, Ga, Nb, Mo, Ti, Zr, Mg, Zn, V, and Cu; z is 0.01 to 0.18, and d is 0 to 0.3.

7. The binder precursor composition of claim 1 wherein the electroactive cathode material comprises LiₐNi_{b}Mn_{c}Co_{d}RₑO_{2-f}Z_{f}, wherein:
R is Al, Ni, Co, Mn, Cr, Fe, Mg, Sr, V, Zr, Ti, a rare earth element, or a combination thereof, and Z is F, S, P, or a combination thereof; and
0.8≦a≦1.2, 0.1≦b≦0.5, 0.2≦c≦0.7, 0.05≦d≦0.4, 0≦e≦0.2; wherein the sum of b+c+d+e is about 1; and 0≦f≦0.08.

8. The binder precursor composition of claim 1 wherein the electroactive cathode material comprises a composite material represented by the structure of Formula:
x(Li_{2-w}A₁₋ᵥQ_{w+v}O₃₋ₑ)*(1−x)(Li_{y}Mn_{2-z}M_{z}O_{4-d})
wherein:
x is about 0.005 to about 0.1;
A comprises one or more of Mn or Ti;
Q comprises one or more of Al, Ca, Co, Cr, Cu, Fe, Ga, Mg, Nb, Ni, Ti, V, Zn, Zr or Y;
e is 0 to about 0.3;
v is 0 to about 0.5.
w is 0 to about 0.6;
M comprises one or more of Al, Ca, Co, Cr, Cu, Fe, Ga, Li, Mg, Mn, Nb, Ni, Si, Ti, V, Zn, Zr or Y;
d is 0 to about 0.5;
y is about 0 to about 1; and
z is about 0.3 to about 1; and
wherein the Li_{y}Mn_{2-z}M_{z}O_{4-d} component has a spinel structure and the Li_{2-w}Q_{w+v}A₁₋ᵥO₃₋ₑ component has a layered structure.

9. The binder precursor composition of claim 1 wherein the anhydride is an aromatic anhydride.

10. The binder precursor composition of claim 1 wherein the diamine is an aromatic diamine.

11. The binder precursor composition of claim 1 wherein the aromatic anhydride is selected from the group consisting of pyromellitic dianhydride, 3,3′,4,4′-biphenyl tetracarboxylic dianhydride, 3,3′,4,4′-benzophenone tetracarboxylic dianhydride, 4,4′-oxydiphthalic anhydride, 3,3′,4,4′-diphenyl sulfone tetracarboxylic dianhydride, 2,2-bis(3,4-dicarboxyphenyl) hexafluoropropane, Bisphenol A dianhydride, and mixtures thereof, and the aromatic diamine is selected from the group consisting of 3,4′-oxydianiline, 1,3-bis-(4-aminophenoxy)benzene, 4,4′-oxydianiline, 1,4-diaminobenzene, 1,3-diaminobenzene, 2,2′-bis(trifluoromethyl)benzidene, 4,4′-diaminobiphenyl, 4,4′-diaminodiphenyl sulfide, 9,9′-bis(4-amino)fluorine and mixtures thereof.

12. The binder precursor composition of claim 1 wherein the aromatic dianhydride is pyromellitic dianhydride (PMDA), and the aromatic diamine is oxydianiline.

13. A cathode comprising the binder precursor composition of claim 1 or an imidized form of the binder precursor composition of claim 1

14. An electrochemical cell comprising:
(a) a housing;
(b) an anode and the cathode of claim 13 disposed in the housing and in ionically conductive contact with one another;
(c) an electrolyte composition disposed in the housing and providing an ionically conductive pathway between the anode and the cathode; and
(d) a porous separator between the anode and the cathode.

15. The electrochemical cell of claim 14, wherein the electrochemical cell is a lithium ion battery.

16. The lithium ion battery of claim 15, wherein the anode is lithium titanate or graphite.

17. The lithium ion battery of claim 15, wherein the electrolyte composition comprises a fluorinated acyclic carboxylic acid.

18. A transportation device, electronic devise, computer, telecommunications device, camera, radio or a power tool comprising the lithium ion battery of claim 15.

19. A method to prepare a cathode of an electrochemical cell, comprising the steps of:
(a) combining a polyamic acid that has an anhydride to amine ratio of greater than or equal to about 0.985:1 to less than or equal to about 1.10:1 with a solvent and an electroactive cathode material to form a binder precursor mixture; and
(b) applying the binder precursor mixture to a cathode current collector.

20. The method of claim 19 further comprising the step of:
(c) imidizing the binder precursor mixture.
